(19) United States
(12) Patent Application Publication
(10) Pub. No.: US 2026/0238453 A1
(43) Pub. Date: Aug. 13, 2026

(54) TRANSMISSION CONFIGURATION INDICATOR TECHNIQUES

(71) Applicant: GOOGLE LLC, Mountain View, CA (US)

(72) Inventors: Yushu ZHANG, Beijing (CA); Jia-Hong LIOU, Taipei City (CN)

(21) Appl. No.: 19/156,883

(22) PCT Filed: Aug. 31, 2023
(86) PCT No.: PCT/CN2023/116266

§ 371 Date: Aug. 14, 2025

(30) Foreign Application Priority Data
Feb. 17, 2023 (WO) PCT/CN2023/076948

(51) Int. Cl. H04L 5/00; H04W 8/24

(52) U.S. Cl. CPC H04L 5/0096; H04W 8/24

(57) ABSTRACT

This disclosure provides systems, devices, apparatus, and methods, including computer programs encoded on storage media, for indicating TCI states. A UE 102 receives 508, from a network entity, on a PDSCH, a MAC-CE that activates a subset of TCI states from a list of TCI states. The UE transmits 512, to the network entity, an ACK for the PDSCH on a PUSCH. The UE communicates 516 with the network entity based on an action time associated with the activated subset of TCI states.

### CROSS REFERENCE TO RELATED APPLICATION(S)

This application claims the benefit of and priority to PCT international application No. PCT/CN2023/076948, entitled “TRANSMISSION CONFIGURATION INDICATOR TECHNIQUES” and filed on Feb. 17, 2023, which is expressly incorporated by reference herein in its entirety.

### TECHNICAL FIELD

The present disclosure relates generally to wireless communication, and more particularly, to transmission configuration indicator (TCI) techniques.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (5G UE), etc. The 5G NR architecture seeks to provide increased data rates, decreased latency, and/or increased capacity compared to prior generation cellular communication systems.

Wireless communication systems, in general, provide various telecommunication services (e.g., telephony, video, data, messaging, etc.) based on multiple-access technologies, such as orthogonal frequency division multiple access (OFDMA) technologies, that support communication with multiple UEs. Improvements in mobile broadband continue the progression of such wireless communication technologies. For example, determining an action time for a TCI activation may be of increased complexity.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A network entity, such as a base station or a unit of a base station, and a user equipment (UE) utilize analog beamforming to increase the link budget. The network entity and the UE may maintain a plurality of beams. A good network-UE beam pair can greatly increase the link budget, thus providing significant coverage gain. The beam selection procedure is generally performed in two steps: 1) beam measurement and report; and 2) beam indication. The network entity can indicate the beam by indicating one of the transmission configuration indicator (TCI) states in a TCI state list configured by radio resource control (RRC) signaling.

For the unified TCI based beam indication, the network entity can indicate a joint TCI to update the beam for both uplink and downlink channels or indicate a downlink TCI to update the beam for downlink channels and/or an uplink TCI to update the beam for uplink channels. The network entity can configure a TCI list for a bandwidth part (BWP) by RRC signaling and activate a subset of TCI states by a medium access control-control element (MAC-CE). Then, if the activated TCI states correspond to more than one TCI-codepoints, the network entity can transmit downlink control information (DCI) to select the TCI state(s) corresponding to one TCI-codepoint for further communication.

For the TCI activation, the UE starts to apply the TCI states at 3 ms after the UE transmits the physical uplink control channel (PUCCH) with the acknowledgement (ACK) for the physical downlink shared channel (PDSCH) with the MAC-CE. However, in some examples, the UE may transmit the ACK in PUSCH. The PUSCH may be scheduled to be transmitted on one or more PUSCH transmission occasions in one or multiple slots. But the UE may transmit the ACK in one of the PUSCH transmission occasions (or one of the slots). Hence, determining the action time for the TCI activation when the UE transmits the ACK by the PUSCH on one or more PUSCH transmission occasions in one or multiple slots may be of increased complexity.

The present disclosure addresses the above-noted and other deficiencies by determining the action time for the activated TCI states. The UE may report UE capability indicating that the UE supports TCI activation with PUSCH based ACK/negative-acknowledgment (NACK). Based on the received UE capability, the network entity transmits a RRC signaling configuring at least one TCI state list. The network entity may optionally configure the UE behavior on the action time counting for the TCI activation, e.g., the starting point to count the action time for TCI activation signaling. The network entity then transmits a PDSCH with MAC-CE activating a subset of TCI states from a list of TCI states. Then the UE transmits the PUSCH, with ACK, on one or more PUSCH transmission occasions in one or multiple slots. Then the network entity and UE may determine the action time for the activated TCI states. For example, the UE and network entity determine the action time for the indicated active TCI states with the last symbol of the PUSCH transmission as the starting point. Then the UE and network entity start to apply the indicated active TCI states after the TCI activation delay from the last symbol of the PUSCH with the ACK (for the PDSCH with the MAC-CE based TCI activation). For yet another example, the network entity configures the starting point to count the action time of TCI activation based on the last symbol of the whole PUSCH transmission, or the last symbol of the PUSCH transmission occasion with the ACK, by RRC signaling, MAC-CE, or DCI. The network entity and UE may further communicate based on the activated TCI states after the action time.

According to some aspects, a UE receives, from a network entity, on a physical downlink shared channel (PDSCH), a medium access control-control element (MAC-CE) that activates a subset of transmission configuration indicator (TCI) states from a list of TCI states. The UE transmits, to the network entity, an acknowledgement (ACK) for the PDSCH on a physical uplink shared channel (PUSCH). The UE communicates with the network entity based on an action time associated with the activated subset of TCI states.

According to some aspects, a network entity transmits, to a UE, on a PDSCH, an MAC-CE that activates a subset of TCI states from a list of TCI states. The network entity receives, from the UE, an ACK for the PDSCH on a PUSCH. The network entity communicates with the UE based on an action time associated with the activated subset of TCI states.

In this way, the network can schedule the ACK/NACK feedback for a TCI activation signaling by PUSCH. Such techniques reduce system overhead, e.g., the network does not need to schedule a dedicated PUCCH to transmit the ACK/NACK feedback for TCI activation. The techniques can reduce TCI indication latency. The reduced TCI indication latency can further improve the system performance, since the network entity and the UE can apply improved beams with lower latency. The techniques further improve scheduling flexibility of the network.

### BRIEF DESCRIPTION OF THE DRAWINGS

FIG. 1 illustrates a diagram of a wireless communications system that includes a plurality of user equipments (UEs) and network entities in communication over one or more cells according to an embodiment.

FIG. 2 illustrates an example for TCI indication for a single TRP (sTRP) operation according to an embodiment.

FIG. 3 illustrates an example for TCI indication for a multiple TRPs (mTRP) operation according to an embodiment.

FIG. 4 illustrates a diagram of TCI indication with PUSCH to transmit an ACK/NACK.

FIG. 5 illustrates a signaling diagram for TCI activation with PUSCH based ACK/NACK feedback according to an embodiment.

FIG. 6 illustrates a flow diagram at a UE for TCI activation with PUSCH based ACK/NACK feedback according to an embodiment.

FIG. 7 illustrates a flow diagram at a network entity for TCI activation with PUSCH based ACK/NACK feedback according to an embodiment.

FIG. 8 illustrates an example for TCI activation with the last symbol of the PUSCH as the starting point according to an embodiment.

FIG. 9 illustrates an example for TCI activation with the last symbol of PUSCH transmission occasion including the ACK as the starting point according to an embodiment.

FIG. 10 illustrates an example for the action time of TCI activation update based on the transmission duration for the PUSCH according to an embodiment.

FIG. 11 illustrates a method of wireless communication at a UE for TCI activation with PUSCH based ACK/NACK feedback.

FIG. 12 illustrates a method of wireless communication at a network entity for TCI activation with PUSCH based ACK/NACK feedback.

FIG. 13 is a diagram illustrating a hardware implementation for an example UE apparatus according to some embodiments.

FIG. 14 is a diagram illustrating a hardware implementation for one or more example network entities according to some embodiments.

### DETAILED DESCRIPTION

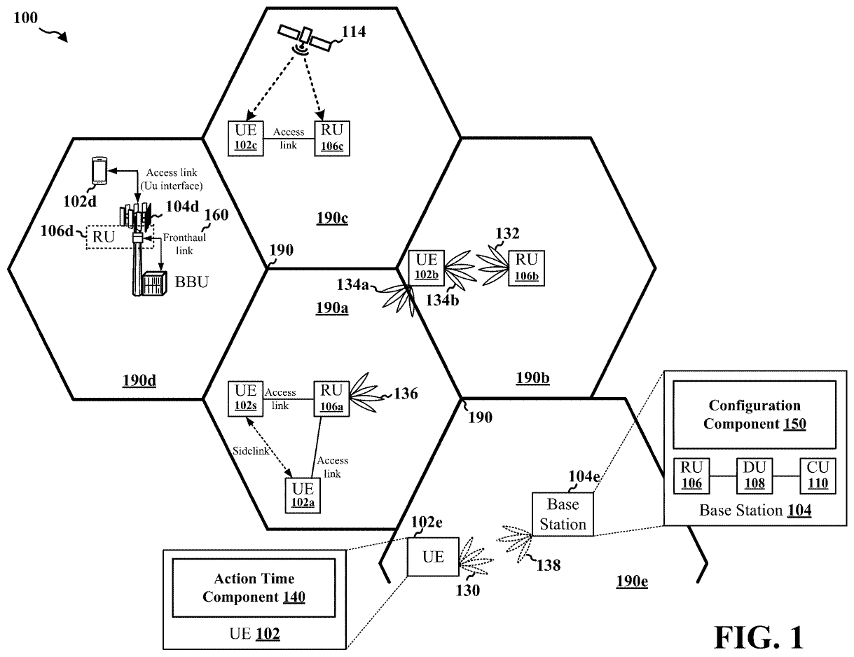

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104d, 104e and/or the RUs 106a, 106b, 106c, 106d may communicate with the UEs 102a, 102b, 102c, 102d, and/or 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108 and the CU 110. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (IFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. DUs 108 can control both real-time and non-real-time features of control plane and user plane communications of the RUs 106.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 may relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal (e.g., sounding reference signal (SRS)) to the RU 106b based on the second set of communication beams 134b in one or more transmit directions of the UE 102b. The RU 106b may receive the uplink beamformed signal from the UE 102b in one or more receive directions of the RU 106b. The UE 102b may perform beam training to determine the best receive and transmit directions for the beamformed signals. The transmit and receive directions for the UEs 102 and the base stations 104/RUs 106 may or may not be the same.

In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 associated with the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include an action time component 140 configured to receive, from a network entity, on a PDSCH, an MAC-CE that activates a subset of TCI states from a list of TCI states. The action time component 140 is configured to transmit, to the network entity, an ACK for the PDSCH on a PUSCH. The action time component 140 is configured to communicate with the network entity based on an action time associated with the activated subset of TCI states.

In certain aspects, any of the base stations 104 or a network entity of the base stations 104 may include a configuration component 150 configured to transmit, to a UE, on a PDSCH, an MAC-CE that activates a subset of TCI states from a list of TCI states. The configuration component 150 is configured to receive, from the UE, an ACK for the PDSCH on a PUSCH. The configuration component 150 is configured to communicate with the UE based on an action time associated with the activated subset of TCI states.

Accordingly, FIG. 1 describes a wireless communication system that may be implemented in connection with aspects of one or more other figures described herein. Further, although the following description may be focused on 5G NR, the concepts described herein may be applicable to other similar areas, such as 5G-Advanced and future versions, LTE, LTE-advanced (LTE-A), and other wireless technologies, such as 6G.

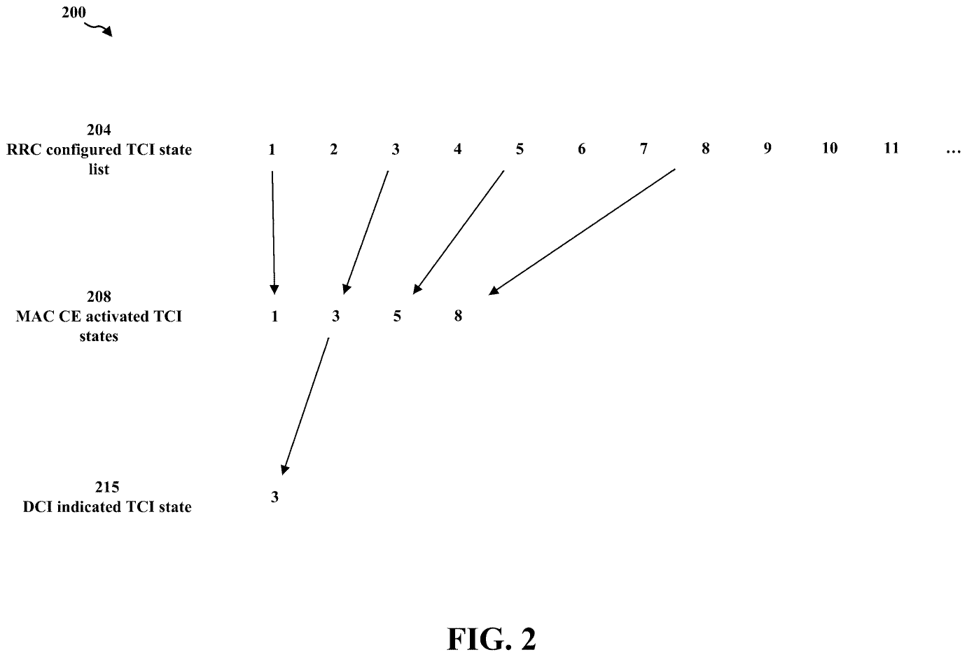

FIG. 2 illustrates a diagram 200 of an example for TCI indication for a single TRP (sTRP) according to an embodiment. To increase the link budget, analog beamforming can be utilized at the network entity and UE side. The network entity and UE may maintain a plurality of beams. A good network-UE beam pair can greatly increase the link budget, thus providing significant coverage gain. The beam selection procedure is generally performed in two steps: 1) beam measurement and report, and 2) beam indication. The network entity can indicate the beam by indicating one of the TCI states in a TCI state list configured by RRC signaling. The network can configure different quasi-co-location (QCL) source reference signal for different TCI states. In one example, the QCL source reference signal may be a synchronization signal block (SSB). The SSB may be from the serving cell (e.g., the SSB is based on a physical cell identifier (PCI) from the serving cell) or a neighbor cell (e.g., the SSB is based on a PCI other than the PCI from the serving cell). In another example, the QCL source reference signal may be a channel state information reference signal (CSI-RS). The CSI-RS may be quasi-co-located with an SSB from the serving cell or a neighbor cell.

For the unified TCI based beam indication, the network entity can indicate a joint TCI to update the beam for both uplink and downlink channels or indicate a downlink TCI to update the beam for downlink channels and/or an uplink TCI to update the beam for uplink channels. The network entity can configure a TCI state list for a bandwidth part (BWP) by RRC signaling and activate a subset of TCI states of the TCI state list by MAC-CE. The activated TCI states correspond to different TCI-codepoints in downlink control information (DCI). If the subset of activated TCI states corresponds to more than one TCI-codepoint, the network entity can transmit a DCI to select the TCI state(s) from the subset of activated TCI states corresponding to one TCI-codepoint for further communication; otherwise, the network entity and UE use the TCI state corresponding to the one TCI-codepoint for further communication after applying the TCI activation signaling.

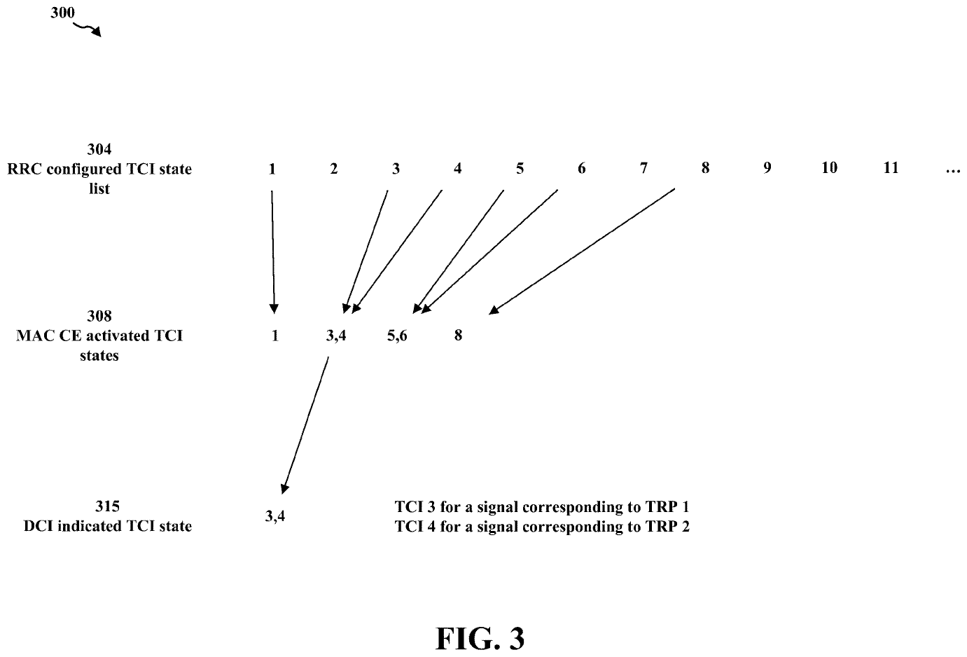

Referring to FIG. 2, the network entity may configure a TCI state list for a BWP by RRC signaling 204. The TCI state list may include TCI 1-TCI 11, etc. The network entity may activate a subset of TCI states by MAC-CE 208. For example, the subset of TCI states includes TCI 1, TCI 3, TCI 5, and TCI 8. If the activated subset of TCI states (e.g., TCI 1, TCI 3, TCI 5, and TCI 8) correspond to more than one TCI-codepoint, the network entity may transmit 215 a DCI to select one or more TCI states from the subset of activated TCI states corresponding to one TCI-codepoint for further communication. Continuing with the example, the network entity may transmit 215 the DCI to select a TCI state, e.g., TCI 3. FIG. 2 illustrates the example for the TCI indication for the sTRP operation. FIG. 3 illustrates an example for a TCI indication for a multiple TRPs (mTRP) operation.

FIG. 3 illustrates a diagram 300 of an example for a TCI indication for an mTRP operation according to an embodiment. The difference between FIG. 2 and FIG. 3 is that: the network entity only indicates one TCI state in FIG. 2; the network entity indicates multiple TCI states and each indicated TCI state can correspond to a signal for one TRP in FIG. 3.

Referring to FIG. 3, the network entity may configure a TCI state list for a BWP by RRC signaling 304. The TCI state list may include TCI 1-TCI 11, etc. The network entity may activate a subset of TCI states of the TCI state list by MAC-CE 308. For example, the subset of TCI states includes TCI 1, TCI 3 and TCI 4, TCI 5 and TCI 6, and TCI 8. If the activated subset of TCI states corresponds to more than one TCI-codepoint, the network entity may transmit 315 a DCI to select one or more TCI states from the subset of activated TCI states corresponding to one TCI-codepoint for further communication. Continuing with the example, the network entity may transmit 315 the DCI to select two TCI states, e.g., TCI 3 for a signal corresponding to TRP 1 and TCI 4 for a signal corresponding to TRP 2.

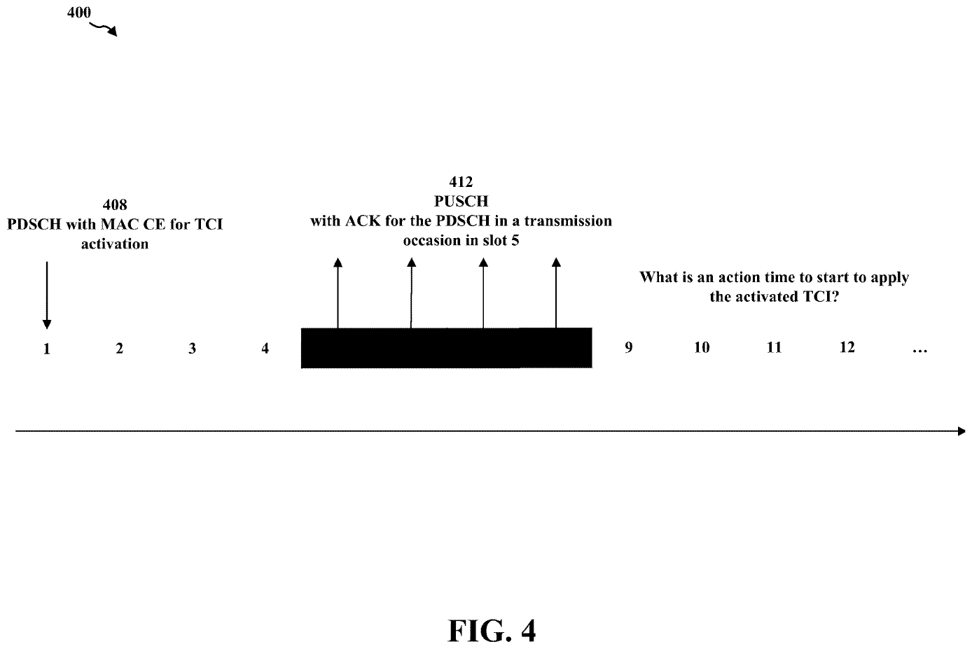

FIG. 4 illustrates a diagram 400 of TCI indication with PUSCH to transmit an ACK/NACK. For TCI activation, the UE may start to apply the TCI states at a time duration, e.g., 3 milliseconds (ms), after the UE transmits the PUCCH with the ACK of the PDSCH, which was transmitted by the MAC-CE. However, UE may transmit the ACK in PUSCH, and the UE may transmit the PUSCH in one or multiple slots (or one or multiple transmission occasions). In some aspects, the UE may transmit the ACK in one of the PUSCH transmission occasions (or one of the slots).

Referring to FIG. 4, the network entity may activate a subset of TCI states of a list of TCI states by a MAC-CE. The network entity may transmit 408 a PDSCH with the MAC-CE for the TCI indication. The UE may transmit 412 a PUSCH with the ACK for the PDSCH. The UE may start to apply the subset of activated TCI states at a time duration, e.g., 3 milliseconds (ms), after the UE transmits the PUSCH with the ACK for the PDSCH. The PUSCH may be scheduled to be transmitted on one or more PUSCH transmission occasions in one or multiple slots, e.g., slot 5, slot 6, slot 7, and slot 8. But the UE may transmit the ACK in one of the PUSCH transmission occasions (or one of the slots), e.g., a transmission occasion in slot 5, as shown in FIG. 4. It is challenging to determine the action time for the TCI activation when the UE transmits the ACK by PUSCH.

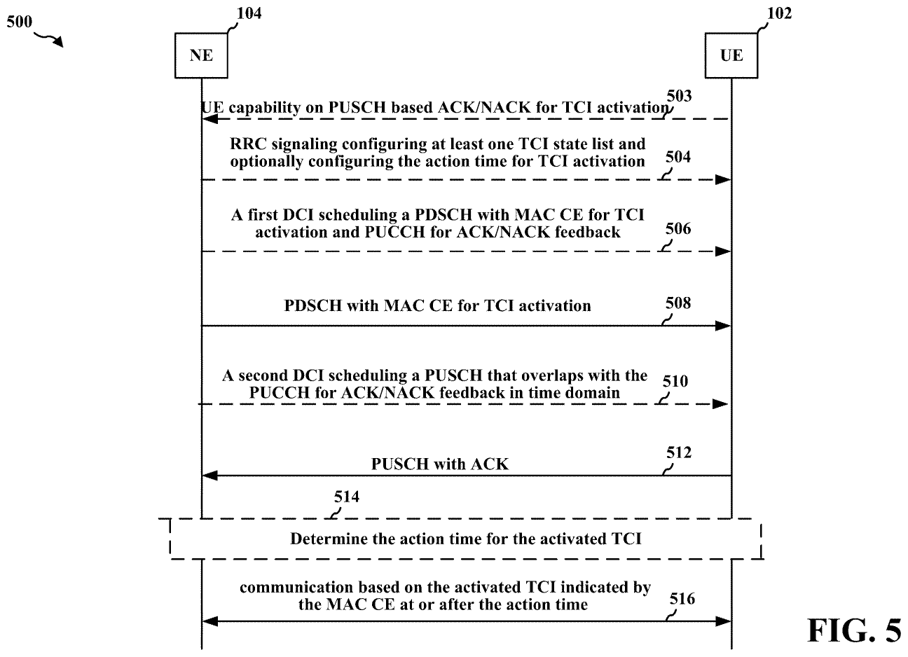

FIG. 5 illustrates a signaling diagram 500 for TCI activation with PUSCH based ACK/NACK feedback according to an embodiment. The network entity 104 may correspond to a base station or a unit of a base station, such as the RU 106, the DU 108, the CU 110, etc. The UE 102 may transmit 503 (the network entity may receive 503) UE capability report indicating that the UE 102 supports TCI activation with PUSCH based ACK/NACK. In examples, the network entity may receive 503 the UE capability from a UE or from a core network (e.g., Access and Mobility Management Function (AMF)) or from another network entity.

Based on the received UE capability, the network entity 104 may transmit 504 (the UE 102 may receive 504) RRC signaling configuring at least one TCI state list, e.g., dl-OrJoint-TCIStateList and/or ul-TCI-StateList. The network entity may configure a list of TCI states for a BWP by RRC signaling. The network entity 104 may optionally configure 504 the UE behavior on the action time counting for the TCI activation, e.g., the starting point to count the action time for TCI activation signaling. The network entity 104 may transmit 504 (the UE 102 may receive 504), the RRC signaling configuring the list of TCI states and the action time associated with the activated subset of TCI states. As referred to herein, unless otherwise specified, RRC signaling from the network entity to the UE may indicate an RRC reconfiguration message, or a system information block (SIB), where the SIB can be an existing SIB (e.g., SIB1) or a new SIB (e.g., SIB J, where J is an integer above 21) transmitted by the network entity. RRC signaling from the network entity to the UE may indicate a UE forwarded RRC reconfiguration message.

The network entity 104 may transmit 506 (the UE 102 may receive 506) a first DCI scheduling a PDSCH with MAC-CE based TCI activation and a PUCCH resource for ACK/NACK feedback. The network entity 104 transmits 508 (the UE receives 508) the scheduled PDSCH with the MAC-CE based TCI activation. The network entity transmits 508 (the UE receives 508), on the PDSCH, the MAC-CE that activates a subset of TCI states from the list of TCI states.

The network entity 104 may transmit 510 (the UE may receive 510) a second DCI scheduling a PUSCH that partially or fully overlaps with the PUCCH in time domain. The UE 102 transmits 512 (the network entity receives 512) the PUSCH with ACK/NACK for the PDSCH. The UE 102 transmits 512 (the network entity receives 512) the ACK for the PDSCH on the PUSCH. When the network entity 104 schedules the UE 102 to transmit the PUSCH on one or more PUSCH transmission occasions in one or multiple slots, the UE 102 may transmit 512 (the network entity may receive 512) the ACK/NACK on one of the PUSCH transmission occasions (or one of the slots). The PUSCH may comprise one or more PUSCH transmission occasions in one or more slots. For example, a PUSCH transmission occasion is a set of symbols within a slot, and the UE receives the configuration from the network entity configuring a time duration for each transmission occasion. The PUSCH may comprise multiple PUSCH transmission occasions, and the UE may transmit on one or more than one transmission occasion per slot. The UE may transmit on at least one of the PUSCH transmission occasions in each slot.

The network entity 104 and UE 102 may determine 514 the action time for the subset of indicated or activated TCI states after the network entity 104 receives 512 the PUSCH and after the UE 102 transmits 512 the PUSCH, respectively. The network entity 104 and UE 102 may further communicate 516 based on the subset of indicated activated TCI states at or after the action time of the subset of indicated activated TCI states. The network entity 104 and UE 102 may communicate 516 based on the action time associated with the activated subset of TCI states.

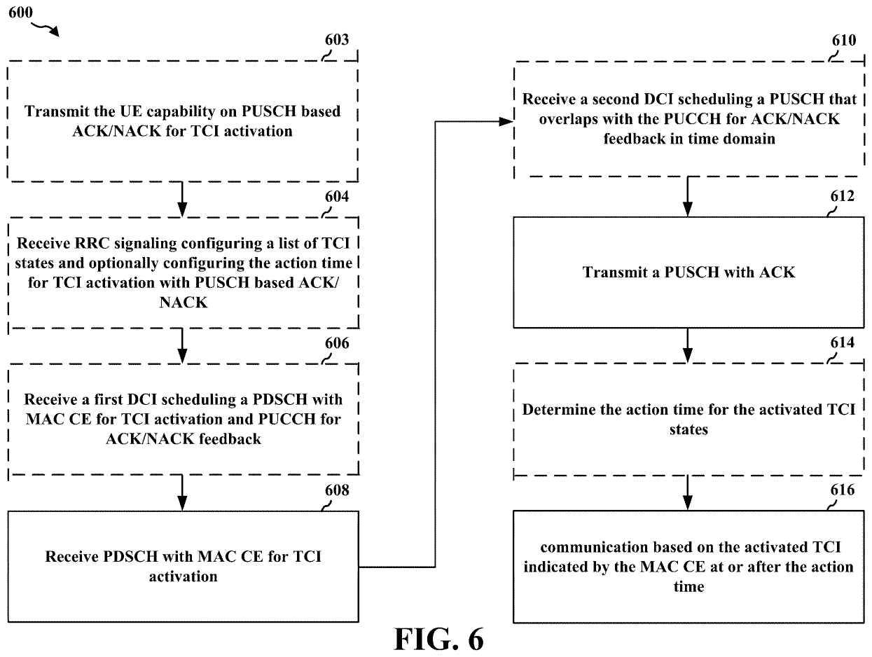

FIG. 6 illustrates a flow diagram 600 for TCI activation with PUSCH based ACK/NACK feedback at a UE according to an embodiment. More specifically, FIG. 6 illustrates the UE behavior on TCI activation with PUSCH based ACK/NACK feedback. The UE 102 may transmit 603 UE capability report indicating that the UE 102 supports TCI activation with PUSCH based ACK/NACK.

Based on the received UE capability, the UE 102 may receive 604 RRC signaling configuring at least one TCI state list, e.g., dl-OrJoint-TCIStateList and/or ul-TCI-StateList. The UE 102 may receive 604 a list of TCI states for a BWP by RRC signaling. The UE 102 may optionally receive 604 the UE behavior on the action time counting for the TCI activation, e.g., the starting point to count the action time for TCI activation signaling.

The UE 102 may receive 606 a first DCI scheduling a PDSCH with MAC-CE based TCI activation and a PUCCH resource for ACK/NACK feedback. The UE receives 608 the scheduled PDSCH with the MAC-CE based TCI activation. The UE receives 608, on the PDSCH, the MAC-CE that activates a subset of TCI states from the list of TCI states.

The UE may receive 610 a second DCI scheduling a PUSCH that overlaps with the PUCCH in time domain. The UE 102 transmits 612 the PUSCH with ACK/NACK for the PDSCH. The UE 102 transmits 612 the ACK for the PDSCH on the PUSCH. When the network entity 104 schedules the UE 102 to transmit the PUSCH on one or more PUSCH transmission occasions in one or multiple slots, the UE 102 may transmit 612 the ACK/NACK on one of the PUSCH transmission occasions (or one of the slots). The PUSCH may comprise one or more PUSCH transmission occasions in one or more slots. For example, a PUSCH transmission occasion is a set of symbols within a slot, and the UE receives the configuration from the network entity configuring a time duration for each transmission occasion. The PUSCH may comprise multiple PUSCH transmission occasions, and the UE may transmit on one or more than one transmission occasion per slot. The UE may transmit on at least one of the PUSCH transmission occasions in each slot.

The UE 102 may determine 614 the action time for the subset of activated TCI states after the UE 102 transmits 612 the PUSCH. The network entity 104 and UE 102 may further communicate 616 based on the subset of activated TCI states after the action time of the subset of activated TCI states.

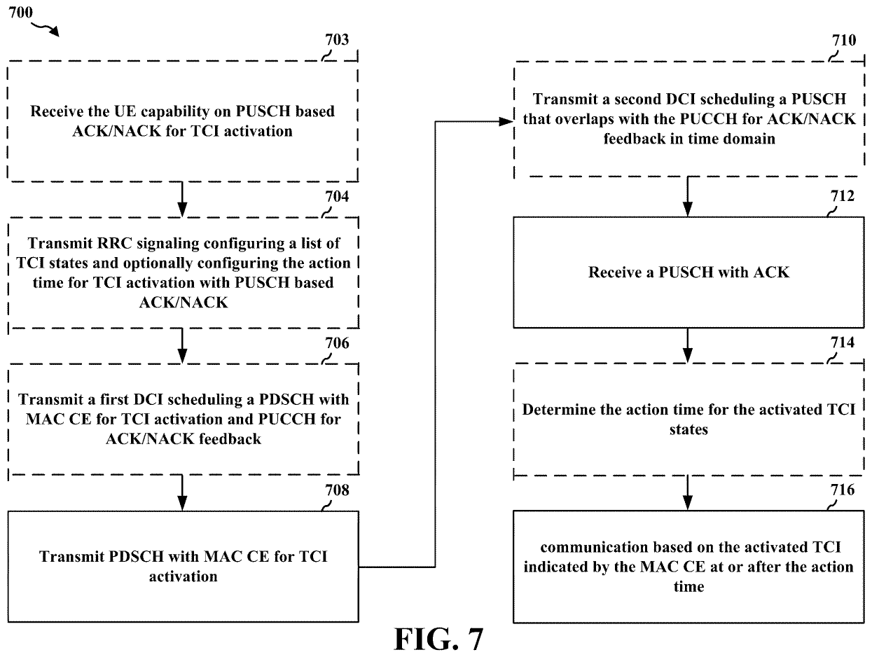

FIG. 7 illustrates a flow diagram 700 for TCI activation with PUSCH based ACK/NACK feedback at a network entity according to an embodiment. More specifically, FIG. 7 illustrates the network entity behavior on TCI activation with PUSCH based ACK/NACK feedback. The network entity may receive 703 UE capability report indicating that the UE 102 supports TCI activation with PUSCH based ACK/NACK.

Based on the received 703 UE capability, the network entity 104 may transmit 704 RRC signaling configuring at least one TCI state list, e.g., dl-OrJoint-TCIStateList and/or ul-TCI-StateList. The network entity may configure a list of TCI states for a BWP by RRC signaling. The network entity 104 may optionally configure 704 the UE behavior on the action time counting for the TCI activation, e.g., the starting point to count the action time for TCI activation signaling.

The network entity 104 may transmit 706 a first DCI scheduling a PDSCH with MAC-CE based TCI activation and a PUCCH resource for ACK/NACK feedback. The network entity 104 transmits 708 the scheduled PDSCH with the MAC-CE based TCI activation. The network entity transmits 708, on the PDSCH, the MAC-CE that activates a subset of TCI states from the list of TCI states.

The network entity 104 may transmit 710 a second DCI scheduling a PUSCH that overlaps with the PUCCH in time domain. The network entity receives 712 the PUSCH with ACK/NACK for the PDSCH. The network entity receives 712 the ACK for the PDSCH on the PUSCH. When the network entity 104 schedules the UE 102 to transmit the PUSCH on one or more PUSCH transmission occasions in one or multiple slots, the network entity may receive 712 the ACK/NACK on one of the PUSCH transmission occasions (or one of the slots). The network entity 104 may determine 714 the action time for the subset of activated TCI states after the network entity 104 receives 712 the PUSCH. The network entity 104 and UE 102 may further communicate 716 based on the subset of activated TCI states after the action time of the subset of activated TCI states.

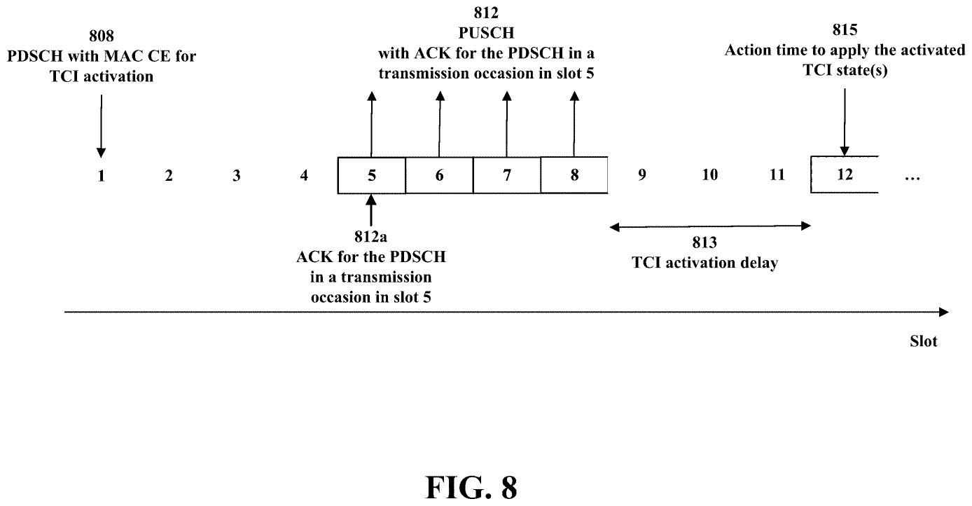

FIG. 8 illustrates an example for TCI activation with a last symbol of a PUSCH 812 as a starting point according to an embodiment. For example, an action time is when the UE or the network entity applies the activated or indicated subset of TCI states. The UE or the network entity may apply the activated or indicated subset of TCI states at the action time or after the action time. The UE or the network entity may apply the activated or indicated subset of TCI states based on the action time. The TCI activation delay may be a time duration to apply the activated or indicated subset of TCI states. As an example, an action time 815 is counted from the last symbol of the PUSCH 812 as the starting point. The action time 815 for the indicated or active TCI states may be determined based on the last symbol of the PUSCH 812 as the starting point to count the TCI activation delay 813.

The UE and network entity determine the action time for the indicated active TCI states with the last symbol of the whole PUSCH transmission, which may be the last symbol of the last actual transmission occasion or nominal transmission occasion for the PUSCH as the starting point. The UE and network entity start to apply the indicated active TCI states after the X ms after the last symbol of the PUSCH with the ACK for the PDSCH with the MAC-CE based TCI activation, where X indicates the TCI activation delay, which can be predefined, e.g., 3 ms, or configured by the network entity via RRC signaling, which may be also determined based on the subcarrier spacing (SCS) of the PUSCH.

Referring to FIG. 8, the network entity 104 transmits (the UE 102 receives) the PDSCH 808 with the MAC-CE based TCI activation. The MAC-CE activates a subset of TCI states from a list of TCI states. The UE transmits (the network entity receives) the PUSCH 812 with an ACK 812a for the PDSCH. The PUSCH may comprise one or more PUSCH transmission occasions in one or more slots. For example, a PUSCH transmission occasion is a set of symbols within a slot, and the UE receives the configuration from the network entity configuring a time duration for each transmission occasion. The PUSCH may comprise multiple PUSCH transmission occasions, and the UE may transmit on one or more than one transmission occasion per slot. The UE may transmit on at least one of the PUSCH transmission occasions in each slot. When the network entity 104 schedules the UE 102 to transmit the PUSCH 812 on one or more PUSCH transmission occasions in one or multiple slots, the UE 102 may transmit (the network entity may receive) the ACK 812a on one of the PUSCH transmission occasions (or one of the slots). As illustrated in FIG. 8, the UE may transmit (the network entity may receive) the PUSCH 812 on one or more PUSCH transmission occasions in slot 5, slot 6, slot 7, and slot 8, and the UE 102 may transmit (the network entity may receive) the ACK 812a on one of the PUSCH transmission occasions in slot 5. The network entity 104 and UE 102 may determine the action time 815 for the subset of indicated or activated TCI states after the network entity 104 receives the PUSCH 812 and after the UE 102 transmits the PUSCH 812, respectively.

The UE 102 and the network entity 104 may determine the action time 815 for the indicated or active TCI states based on the last symbol of the whole PUSCH transmission, which may be the last symbol of the last actual transmission occasion or nominal transmission occasion for the PUSCH 812 as the starting point. The PUSCH may not take a whole slot. For example, the PUSCH may take symbol 1 to 10 in a slot, then the last symbol should be symbol 10 instead of symbol 14 (assuming there are 14 symbols in a slot). As illustrated in FIG. 8, the PUSCH 812 may take symbol 1 to 10 in slot 8, then the last symbol should be symbol 10 instead of symbol 14 in slot 8 (assuming there are 14 symbols in slot 8).

As illustrated in FIG. 8, the UE and the network entity may apply the indicated or active TCI states from a first slot (e.g., slot 12) that is a time duration of a TCI activation delay 813 (e.g., X ms) after the last symbol of the PUSCH 812 with the ACK 812a for the PDSCH 808 with the MAC-CE (providing the MAC-CE). For example, the TCI activation delay 813 can be predefined, e.g., X ms is 3 ms, or configured by the network entity via RRC signaling. The PUSCH 812 may be transmitted on one or more PUSCH transmission occasions in slot 5, slot 6, slot 7, and slot 8, and the ACK 812a may be transmitted on one of the PUSCH transmission occasions in slot 5. The last symbol of the PUSCH 812 may be a last symbol of a last PUSCH transmission occasion in slot 8. In FIG. 8, the TCI action delay is 3 ms and the subcarrier spacing is 15 kHz. The starting point to count the action time of the TCI activation is the last symbol of the PUSCH, e.g., the last symbol of the last PUSCH transmission occasion in the last slot (e.g., slot 8) with the PUSCH. The action time 815 to apply the indicated or active TCI states may be the first slot (e.g., slot 12) that is the time duration of the TCI activation delay 813 (e.g., X ms) after the last symbol of the PUSCH 812 with the ACK 812a for the PDSCH 808 providing the MAC-CE.

In some examples, if the last PUSCH repetition among one or more PUSCH repetitions is dropped or not transmitted due to pre-emption (e.g., invalid uplink slot) or slot format, the last symbol would count on the last PUSCH repetition which is actually transmitted.

In one example, when the UE would transmit the last symbol of a PUCCH or PUSCH with hybrid automatic repeat request-acknowledgment (HARQ-ACK) information in slot n corresponding to the PDSCH carrying the activation command, the indicated mapping between TCI states and codepoints of the DCI field ‘Transmission Configuration Indication’ should be applied starting from the first slot that is after slot

$$n + 3 {N}_{slot}^{subframe , μ} + \frac{{2}^{μ}}{{2}^{{μ}_{{K}_{mac}}}} \cdot {k}_{mac}$$

where μ is the SCS configuration for the PUCCH or PUSCH and μ_{K}_{_{mac}} is the subcarrier spacing configuration for k_{mac} with a value of 0 for frequency range 1, and k_{mac} is provided by K-Mac or k_{mac}=0 if K-Mac is not provided. If tci-PresentInDCI is set to ‘enabled’ or tci-PresentDCI-1-2 is configured for the control resource set (CORESET) scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the demodulation reference signal (DM-RS) ports of PDSCH of a serving cell are quasi co-located with the synchronization signal/physical broadcast channel (SS/PBCH) block determined in the initial access procedure with respect to qcl-Type set to ‘typeA’, and when applicable, also with respect to qcl-Type set to ‘typeD’.

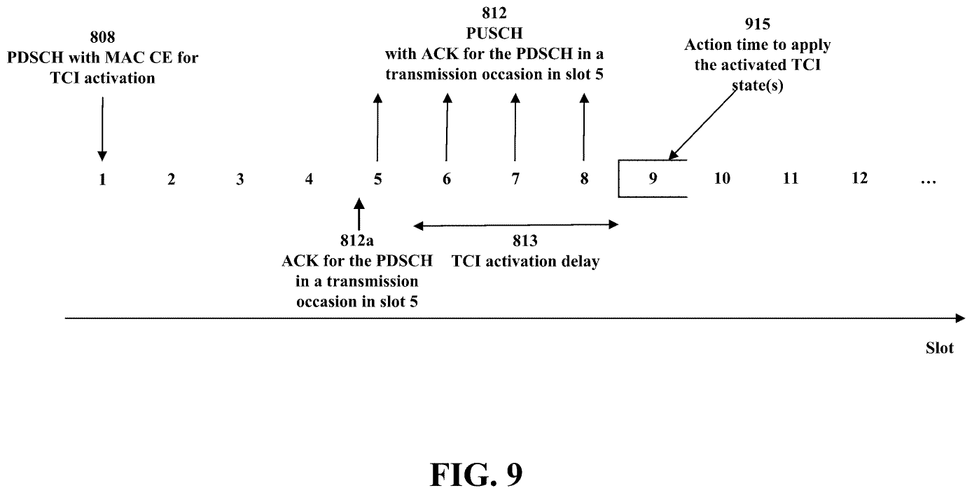

FIG. 9 illustrates an example for TCI activation with a last symbol of a PUSCH transmission occasion including the ACK 812a as a starting point according to an embodiment. For example, an action time 915 is counted from the last symbol of the PUSCH transmission occasion including the ACK 812a as the starting point.

Referring to FIG. 9, the UE and network entity may determine the action time 915 for the indicated active TCI states with the last symbol of the PUSCH transmission occasion including the ACK 812a (e.g., the transmission occasion in slot 5) as the starting point to count a TCI activation delay 813. Then the UE and network entity start to apply the indicated active TCI states after the time duration of the TCI activation delay 813 (e.g., X ms) from the last symbol of the PUSCH transmission occasion including the ACK 812a (e.g., the transmission occasion in slot 5) for the PDSCH 808 with the MAC CE based TCI activation. For example, the TCI activation delay can be predefined, e.g., X ms is 3 ms, or configured by the network entity via RRC signaling, which may be also determined based on the subcarrier spacing of the PUSCH. As illustrated in FIG. 9, the TCI action delay is 3 ms and the subcarrier spacing is 15 kHz. The starting point to count the action time 915 of TCI activation is the last symbol of the last PUSCH transmission occasion including the ACK 812a (e.g., the transmission occasion in slot 5).

In one example, when the UE would transmit the last symbol of the transmission occasion of a PUCCH or PUSCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot

$$n + 3 {N}_{slot}^{subframe , μ} + \frac{{2}^{μ}}{{2}^{{μ}_{{K}_{mac}}}} \cdot {k}_{mac}$$

where μ is the SCS configuration for the PUCCH or PUSCH and μ_{K}_{_{mac}} is the subcarrier spacing configuration for k_{mac} with a value of 0 for frequency range 1, and k_{mac} is provided by K-Mac or k_{mac}=0 if K-Mac is not provided. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’.

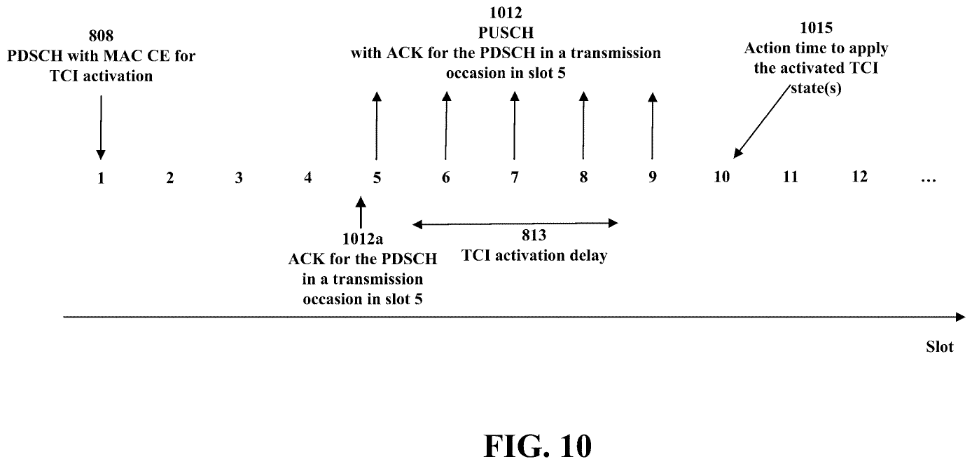

In some examples, if an action time of the TCI activation is before a last slot of the PUSCH 1012 with an ACK 1012a, the network entity and UE may determine the action time 1015 to be the next slot after the last slot of the whole PUSCH 1012. FIG. 10 illustrates an example for an action time 1015 of TCI activation update based on a transmission duration for a whole PUSCH 1012.

Referring to FIG. 10, the UE may transmit (the network entity may receive) the PUSCH 1012 on one or more PUSCH transmission occasions in slot 5, slot 6, slot 7, slot 8, and slot 9. The UE 102 may transmit (the network entity may receive) the ACK 1012a on one of the PUSCH transmission occasions, e.g., in slot 5. The UE and network entity may determine the action time 1015 for the indicated active TCI states based on the last symbol of the PUSCH transmission occasion including the ACK 1012a (e.g., the transmission occasion in slot 5) as the starting point to count the TCI activation delay 813. The UE and network entity may start to apply the indicated active TCI states after the time duration of the TCI activation delay 813 (e.g., X ms) from the last symbol of the PUSCH transmission occasion including the ACK 1012a (e.g., the transmission occasion in slot 5) for the PDSCH 808 with the MAC CE based TCI activation. However, if the transmission duration for the PUSCH 1012 is longer than the time duration of the TCI activation delay from the last symbol of the PUSCH transmission occasion including the ACK 1012a, an action time of the TCI activation may occur before a last slot of the PUSCH 1012 (e.g., slot 9). In this situation, the network entity and UE may determine the action time 1015 to be the next slot (e.g., slot 10) after the last slot of the PUSCH 1012.

In some examples, an action time of a TCI activation counting scheme is configurable. The network entity configures the starting point to count the action time of TCI activation based on the techniques described in connection with FIGS. 8-10 by RRC signaling, MAC-CE, or DCI. The UE may further report UE capability indicating whether the UE supports the TCI activation time counting scheme.

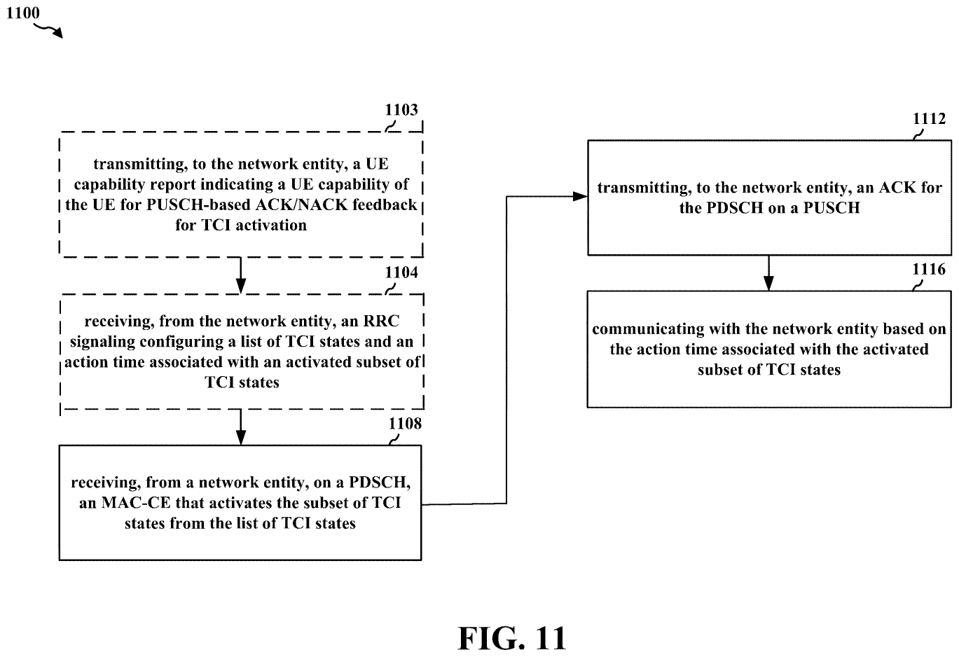

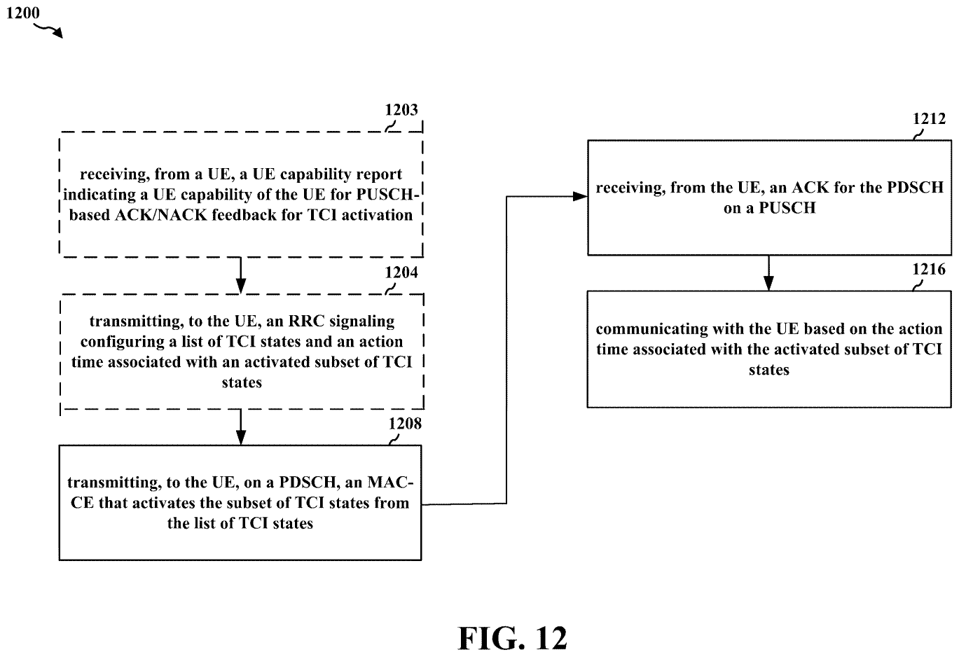

In one example, the network entity configures an RRC parameter indicating whether the UE should count the starting point of the action time of TCI activation based on the last symbol of the last slot (transmission occasion) of the PUSCH with the ACK or the last slot of the whole PUSCH. In other examples, the network entity configures whether the UE should count the starting point of the action time of TCI activation based on the last symbol of the last slot (transmission occasion) of the PUSCH with the ACK or the last slot of the whole PUSCH by a field in the MAC-CE for TCI activation. In further examples, the network entity configures whether the UE should count the starting point of the action time of TCI activation based on the last symbol of the last slot (transmission occasion) of the PUSCH with the ACK or the last slot of the whole PUSCH by a field in the first DCI scheduling the MAC-CE for TCI activation or a field in the second DCI scheduling the PUSCH. FIGS. 2-4 illustrate examples for TCI indication. FIGS. 5-7 illustrate diagrams for TCI activation with PUSCH based ACK/NACK feedback. FIG. 8 illustrates an example for TCI activation with the last symbol of the PUSCH as the starting point. FIGS. 9-10 illustrate examples for TCI activation with the last symbol of PUSCH transmission occasion including the ACK as the starting point. FIGS. 11-12 show methods for implementing one or more aspects of FIGS. 5-10. In particular, FIG. 11 shows an implementation by the UE 102 of the one or more aspects of FIGS. 5-10. FIG. 12 shows an implementation by the network entity 104 of the one or more aspects of FIGS. 5-10.

FIG. 11 illustrates a flowchart of a method 1100 of wireless communication at a UE. With reference to FIGS. 1-10, the method 1100 may be performed by the UE 102. The UE 102 may transmit 1103, to a network entity, a UE capability report indicating a UE capability of the UE for PUSCH-based ACK/NACK feedback for TCI activation. For example, referring to FIG. 5, the UE 102 may transmit 503 (the network entity may receive 503) UE capability report indicating that the UE 102 supports TCI activation with PUSCH based ACK/NACK.

The UE 102 may receive 1104, from the network entity, an RRC signaling configuring a list of TCI states and an action time associated with an activated subset of TCI states. For example, referring to FIG. 5, the network entity 104 may transmit 504 (the UE 102 may receive 504), the RRC signaling configuring the list of TCI states and the action time associated with the activated subset of TCI states.

The UE 102 receives 1108, from the network entity, on a PDSCH, an MAC-CE that activates the subset of TCI states from the list of TCI states. For example, referring to FIG. 5, the network entity transmits 508 (the UE receives 508), on the PDSCH, the MAC-CE that activates a subset of TCI states from the list of TCI states.

The UE 102 transmits 1112, to the network entity, an ACK for the PDSCH on a PUSCH. For example, referring to FIG. 5, the UE 102 transmits 512 (the network entity receives 512) the ACK for the PDSCH on the PUSCH.

The UE 102 communicates 1116 with the network entity based on the action time associated with the activated subset of TCI states. For example, referring to FIG. 5, The network entity 104 and UE 102 may communicate 516 based on the action time associated with the activated subset of TCI states. FIG. 11 describes a method 1100 from a UE-side of a wireless communication link, whereas FIG. 12 describes a method 1200 from a network-side of the wireless communication link.

FIG. 12 is a flowchart of a method 1200 of wireless communication at a network entity. With reference to FIGS. 1-10, the method 1200 may be performed by one or more network entities 104, which may correspond to a base station or a unit of the base station, such as the RU 106, the DU 108, and/or the CU 110. The network entity 104 may receive 1203, from a UE, a UE capability report indicating a UE capability of the UE for PUSCH-based ACK/NACK feedback for TCI activation. For example, referring to FIG. 5, the UE 102 may transmit 503 (the network entity may receive 503) UE capability report indicating that the UE 102 supports TCI activation with PUSCH based ACK/NACK.

The network entity 104 may transmit 1204, to the UE, an RRC signaling configuring a list of TCI states and an action time associated with an activated subset of TCI states. For example, referring to FIG. 5, the network entity 104 may transmit 504 (the UE 102 may receive 504), the RRC signaling configuring the list of TCI states and the action time associated with the activated subset of TCI states.

The network entity 104 transmits 1208, to the UE, on a PDSCH, an MAC-CE that activates the subset of TCI states from the list of TCI states. For example, referring to FIG. 5, the network entity transmits 508 (the UE receives 508), on the PDSCH, the MAC-CE that activates a subset of TCI states from the list of TCI states.

The network entity 104 receives 1212, from the UE, an ACK for the PDSCH on a PUSCH. For example, referring to FIG. 5, the UE 102 transmits 512 (the network entity receives 512) the ACK for the PDSCH on the PUSCH.

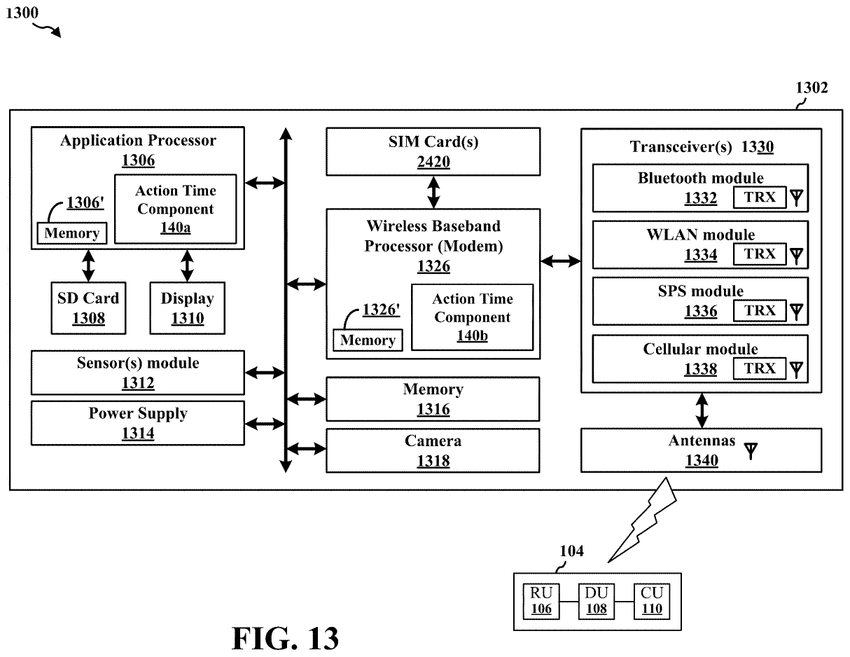

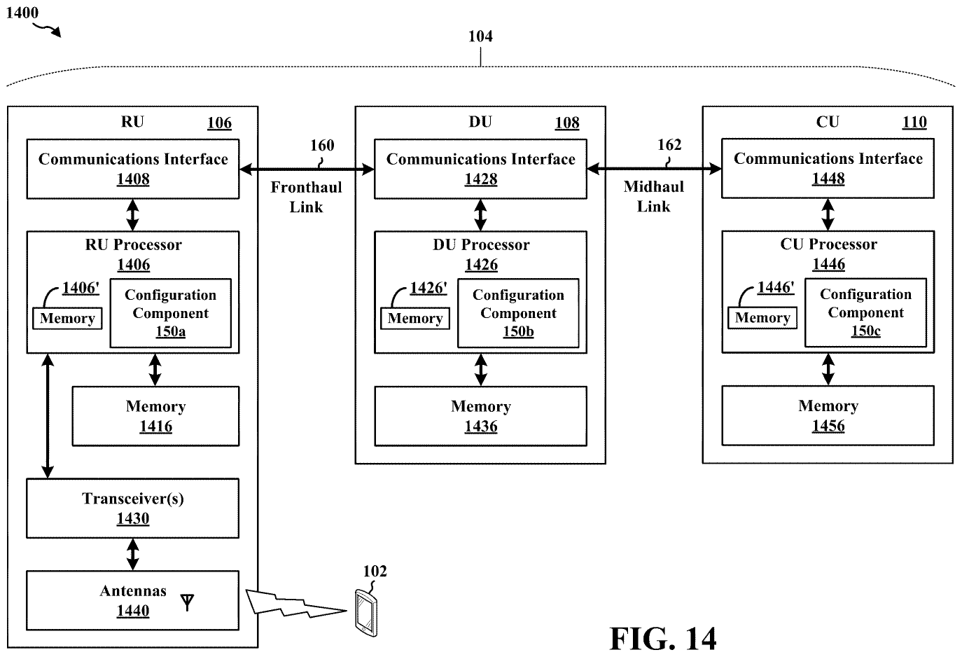

The network entity 104 communicates 1216 with the UE based on the action time associated with the activated subset of TCI states. For example, referring to FIG. 5, The network entity 104 and UE 102 may communicate 516 based on the action time associated with the activated subset of TCI states. A UE apparatus 1302, as described in FIG. 13, may perform the method 1100 of FIG. 11. The one or more network entities 104, as described in FIG. 14, may perform the method 1200 of FIG. 12.

FIG. 13 is a diagram 1300 illustrating an example of a hardware implementation for a UE apparatus 1302. The UE apparatus 1302 may be the UE 102, a component of the UE 102, or may implement UE functionality. The UE apparatus 1302 may include an application processor 1306, which may have on-chip memory 1306′. In examples, the application processor 1306 may be coupled to a secure digital (SD) card 1308 and/or a display 1310. The application processor 1306 may also be coupled to a sensor(s) module 1312, a power supply 1314, an additional module of memory 1316, a camera 1318, and/or other related components.

The UE apparatus 1302 may further include a wireless baseband processor 1326, which may be referred to as a modem. The wireless baseband processor 1326 may have on-chip memory 1326′. Along with, and similar to, the application processor 1306, the wireless baseband processor 1326 may also be coupled to the sensor(s) module 1312, the power supply 1314, the additional module of memory 1316, the camera 1318, and/or other related components. The wireless baseband processor 1326 may be additionally coupled to one or more subscriber identity module (SIM) card(s) 1320 and/or one or more transceivers 1330 (e.g., wireless RF transceivers).

Within the one or more transceivers 1330, the UE apparatus 1302 may include a Bluetooth module 1332, a WLAN module 1334, an SPS module 1336 (e.g., GNSS module), and/or a cellular module 1338. The Bluetooth module 1332, the WLAN module 1334, the SPS module 1336, and the cellular module 1338 may each include an on-chip transceiver (TRX), or in some cases, just a transmitter (TX) or just a receiver (RX). The Bluetooth module 1332, the WLAN module 1334, the SPS module 1336, and the cellular module 1338 may each include dedicated antennas and/or utilize antennas 1340 for communication with one or more other nodes. For example, the UE apparatus 1302 can communicate through the transceiver(s) 1330 via the antennas 1340 with another UE (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1326 and the application processor 1306 may each include a computer-readable medium/memory 1326′, 1306′, respectively. The additional module of memory 1316 may also be considered a computer-readable medium/memory. Each computer-readable medium/memory 1326′, 1306′, 1316 may be non-transitory. The wireless baseband processor 1326 and the application processor 1306 may each be responsible for general processing, including execution of software stored on the computer-readable medium/memory 1326′, 1306′, 1316. The software, when executed by the wireless baseband processor 1326/application processor 1306, causes the wireless baseband processor 1326/application processor 1306 to perform the various functions described herein. The computer-readable medium/memory may also be used for storing data that is manipulated by the wireless baseband processor 1326/application processor 1306 when executing the software. The wireless baseband processor 1326/application processor 1306 may be a component of the UE 102. The UE apparatus 1302 may be a processor chip (e.g., modem and/or application) and include just the wireless baseband processor 1326 and/or the application processor 1306. In other examples, the UE apparatus 1302 may be the entire UE 102 and include the additional modules of the apparatus 1302.

As discussed in FIG. 1 and implemented with respect to FIG. 11, the action time component 140 is configured to receive, from a network entity, on a PDSCH, an MAC-CE that activates a subset of TCI states from a list of TCI states. The action time component 140 is configured to transmit, to the network entity, an ACK for the PDSCH on a PUSCH. The action time component 140 is configured to communicate with the network entity based on an action time associated with the activated subset of TCI states. The action time component 140 may be within the application processor 1306 (e.g., at 140a), the wireless baseband processor 1326 (e.g., at 140b), or both the application processor 1306 and the wireless baseband processor 1326. The action time component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 14 is a diagram 1400 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1446, which may have on-chip memory 1446′. In some aspects, the CU 110 may further include an additional module of memory 1456 and/or a communications interface 1448, both of which may be coupled to the CU processor 1446. The CU 110 can communicate with the DU 108 through a midhaul link 162, such as an F1 interface between the communications interface 1448 of the CU 110 and a communications interface 1428 of the DU 108.

The DU 108 may include a DU processor 1426, which may have on-chip memory 1426′. In some aspects, the DU 108 may further include an additional module of memory 1436 and/or the communications interface 1428, both of which may be coupled to the DU processor 1426. The DU 108 can communicate with the RU 106 through a fronthaul link 160 between the communications interface 1428 of the DU 108 and a communications interface 1408 of the RU 106.

The RU 106 may include an RU processor 1406, which may have on-chip memory 1406′. In some aspects, the RU 106 may further include an additional module of memory 1416, the communications interface 1408, and one or more transceivers 1430, all of which may be coupled to the RU processor 1406. The RU 106 may further include antennas 1440, which may be coupled to the one or more transceivers 1430, such that the RU 106 can communicate through the one or more transceivers 1430 via the antennas 1440 with the UE 102.

The on-chip memory 1406′, 1426′, 1446′ and the additional modules of memory 1416, 1436, 1456 may each be considered a computer-readable medium/memory. Each computer-readable medium/memory may be non-transitory. Each of the processors 1406, 1426, 1446 is responsible for general processing, including execution of software stored on the computer-readable medium/memory. The software, when executed by the corresponding processor(s) 1406, 1426, 1446 causes the processor(s) 1406, 1426, 1446 to perform the various functions described herein. The computer-readable medium/memory may also be used for storing data that is manipulated by the processor(s) 1406, 1426, 1446 when executing the software. In examples, the configuration component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 12, the configuration component 150 is configured to transmit, to a UE, on a PDSCH, an MAC-CE that activates a subset of TCI states from a list of TCI states. The configuration component 150 is configured to receive, from the UE, an ACK for the PDSCH on a PUSCH. The configuration component 150 is configured to communicate with the UE based on an action time associated with the activated subset of TCI states. The configuration component 150 may be within one or more processors of the one or more network entities 104, such as the RU processor 1406 (e.g., at 150a), the DU processor 1426 (e.g., at 150b), and/or the CU processor 1446 (e.g., at 150c). The configuration component 150a-150c may be one or more hardware components specifically configured to carry out the stated processes/algorithm, implemented by one or more processors 1406, 1426, 1446 configured to perform the stated processes/algorithm, stored within a computer-readable medium for implementation by the one or more processors 1406, 1426, 1446, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more. Terms or articles such as “a”, “an”, and/or “the” may refer to one of an item, feature, element, etc., that the term or article precedes, or may refer to more than one of said item, feature, element, etc. that the term or article precedes. For example, the recitation “a widget” does not preclude reference to multiples of said widget, as “multiple widgets” necessarily includes “a widget”. Hence, the recitation “a widget” may be interpreted as “at least one widget” or, similarly, interpreted as “one or more widgets”.

Unless otherwise specifically indicated, ordinal terms such as “first” and “second” do not necessarily imply an order in time, sequence, numerical value, etc., but are used to distinguish between different instances of a term or phrase that follows each ordinal term.

Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers but have one or more of the same trailing numbers (e.g., 206, 306, 406, etc., may refer to similar features in the drawings). Hence, like numbers may refer to like actions.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity (104), on a physical downlink shared channel (PDSCH), a medium access control-control element (MAC-CE) that activates a subset of transmission configuration indicator (TCI) states from a list of TCI states; transmitting, to the network entity, an acknowledgement (ACK) for the PDSCH on a physical uplink shared channel (PUSCH); and communicating with the network entity based on an action time associated with the activated subset of TCI states.

Example 2 may be combined with example 1 and includes that the PUSCH comprises one or more PUSCH transmission occasions in one or more slots, and the transmitting comprises transmitting on at least one of the one or more PUSCH transmission occasions in each slot of the one or more slots.

Example 3 may be combined with any of the examples 1-2 and further includes that receiving, from the network entity, a radio resource control (RRC) signaling configuring the list of TCI states and the action time associated with the activated subset of TCI states.

Example 4 may be combined with any of Examples 1-3 and further includes applying the activated subset of TCI states based on the action time.

Example 5 may be combined with any of Examples 1~4 and further includes that transmitting, to the network entity, a UE capability report indicating a UE capability of the UE for PUSCH-based acknowledgment/negative-acknowledgment (ACK/NACK) feedback for TCI activation.

Example 6 may be combined with any of Examples 1~4 and includes that the action time is based on a TCI activation delay from a last symbol of the PUSCH.

Example 7 may be combined with Example 6 and includes that the UE applies the activated subset of TCI states from a first slot that is a time duration of the TCI activation delay after the last symbol of the PUSCH with the ACK.

Example 8 may be combined with any of Examples 1-5 and includes that the action time is based on a TCI activation delay from a last symbol of a PUSCH transmission occasion that includes the ACK for the PDSCH.

Example 9 may be combined with Example 8 and includes that in response to the action time is before a last symbol of the PUSCH with the ACK, the UE applies the activated subset of TCI states at a next slot after the last symbol of the PUSCH.

Example 10 may be combined with any of Examples 1-5 and includes that the MAC-CE indicates the action time is based on a TCI activation delay from a last symbol of the PUSCH or a last symbol of a PUSCH transmission occasion that includes the ACK for the PDSCH.

Example 11 may be combined with any of Examples 2-5 and includes that the RRC signaling indicates that the action time is based on a TCI activation delay from a last symbol of the PUSCH or a last symbol of a PUSCH transmission occasion that includes the ACK for the PDSCH.

Example 12 is a method of wireless communication at a network entity, including: transmitting, to a user equipment (UE), on a physical downlink shared channel (PDSCH), a medium access control-control element (MAC-CE) that activates a subset of transmission configuration indication (TCI) states from a list of TCI states; receiving, from the UE, an acknowledgement (ACK) for the PDSCH on a physical uplink shared channel (PUSCH); and communicating with the UE based on an action time associated with the activated subset of TCI states.

Example 13 may be combined with Example 12 and includes that the PUSCH comprises one or more PUSCH transmission occasions in one or more slots, and the receiving comprises receiving on at least one of the one or more PUSCH transmission occasions in each slot of the one or more slots.

Example 14 may be combined with any of Examples 12-13 and includes that transmitting, to the UE, a radio resource control (RRC) signaling configuring the list of TCI states and the action time associated with the activated subset of TCI states.

Example 15 may be combined with any of Examples 12-14 and includes that applying the activated subset of TCI states based on the action time.

Example 16 may be combined with any of Examples 12-15 and includes that receiving, from the UE, a UE capability report indicating a UE capability of the UE for PUSCH-based acknowledgment/negative-acknowledgment (ACK/NACK) feedback for TCI activation.

Example 17 may be combined with any of Examples 12-16 and includes that the action time is based on a TCI activation delay from a last symbol of the PUSCH.

Example 18 may be combined with Example 17 and includes that the activated subset of TCI states is applied from a first slot that is a time duration of the TCI activation delay after the last symbol of the PUSCH with the ACK.

Example 19 may be combined with any of Examples 12-16 and includes that the action time is based on a TCI activation delay from a last symbol of a PUSCH transmission occasion that includes the ACK for the PDSCH.

Example 20 may be combined with Example 19 and includes that in response to the action time is before a last symbol of the PUSCH with the ACK, the activated subset of TCI states is applied at a next slot after the last symbol of the PUSCH.

Example 21 may be combined with any of Examples 12-16 and includes that the MAC-CE indicates the action time is based on a TCI activation delay from a last symbol of the PUSCH or a last symbol of a PUSCH transmission occasion that includes the ACK for the PDSCH.

Example 22 may be combined with any of Examples 13-16 and includes that the RRC signaling indicates that the action time is based on a TCI activation delay from a last symbol of the PUSCH or a last symbol of a PUSCH transmission occasion that includes the ACK for the PDSCH.

Example 23 is an apparatus for wireless communication for implementing a method as in any of examples 1-22.

Example 24 is an apparatus for wireless communication including means for implementing a method as in any of examples 1-22.

Example 25 is a non-transitory computer-readable medium storing computer executable code, the code when executed by a processor causes the processor to implement a method as in any of examples 1-22.

1. A method of wireless communication at a user equipment (UE), comprising:
receiving, from a network entity, on a physical downlink shared channel (PDSCH), a medium access control-control element (MAC-CE) that activates a subset of transmission configuration indicator (TCI) states from a list of TCI states;
transmitting, to the network entity, an acknowledgement (ACK) for the PDSCH on a physical uplink shared channel (PUSCH); and
communicating with the network entity based on an action time associated with the activated subset of TCI states, wherein the action time is based on a TCI activation delay from a last symbol of the PUSCH that includes the ACK for the PDSCH.

2. The method of claim 1, wherein the PUSCH comprises one or more PUSCH transmission occasions in one or more slots, and wherein the transmitting comprises transmitting on at least one of the one or more PUSCH transmission occasions in each slot of the one or more slots.

3. The method of claim 1, further comprising:
receiving, from the network entity, a radio resource control (RRC) signaling configuring the list of TCI states and the action time associated with the activated subset of TCI states.

4. The method of claim 1, further comprising:
applying the activated subset of TCI states based on the action time.

5. The method of claim 1, further comprising:
transmitting, to the network entity, a UE capability report indicating a UE capability of the UE for PUSCH-based acknowledgment/negative-acknowledgment, ACK/NACK, feedback for TCI activation.

6. The method of claim 1, wherein the UE applies the activated subset of TCI states from a first slot that is a time duration of the TCI activation delay after the last symbol of the PUSCH with the ACK.

7. The method of claim 2, wherein the action time is based on the TCI activation delay from a last symbol of a PUSCH transmission occasion that includes the ACK for the PDSCH.

8. The method of claim 7, wherein, in response to the action time is before a last symbol of the PUSCH with the ACK, the UE applies the activated subset of TCI states at a next slot after the last symbol of the PUSCH.

9. The method of claim 2, wherein the MAC-CE indicates the action time is based on a TCI activation delay from a last symbol of the PUSCH or a last symbol of a PUSCH transmission occasion that includes the ACK for the PDSCH.

10. The method of claim 2, wherein the RRC signaling indicates that the action time is based on a TCI activation delay from a last symbol of the PUSCH or a last symbol of a PUSCH transmission occasion that includes the ACK for the PDSCH.

11. A method of wireless communication at a network entity, comprising:
transmitting, to a user equipment (UE), on a physical downlink shared channel, PDSCH, a medium access control-control element, MAC-CE, that activates a subset of transmission configuration indication, TCI, states from a list of TCI states;
receiving, from the UE, an acknowledgement, ACK, for the PDSCH on a physical uplink shared channel PUSCH; and
communicating with the UE based on an action time associated with the activated subset of TCI states, wherein the action time is based on a TCI activation delay from a last symbol of the PUSCH that includes the ACK for the PDSCH.

12. The method of claim 11, wherein the PUSCH comprises one or more PUSCH transmission occasions in one or more slots, and wherein the receiving comprises receiving on at least one of the one or more PUSCH transmission occasions in each slot of the one or more slots.

13. The method of claim 11, wherein the activated subset of TCI states is applied from a first slot that is a time duration of the TCI activation delay after the last symbol of the PUSCH with the ACK.

14. The method of claim 12, wherein the MAC-CE indicates the action time is based on a TCI activation delay from a last symbol of the PUSCH or a last symbol of a PUSCH transmission occasion that includes the ACK for the PDSCH.

15. An apparatus for wireless communication at a user equipment (UE), comprising:
a transceiver;
a processor; and
a memory coupled to the processor to store instructions, which when executed by the processor, cause the processor to:
receive, from a network entity, on a physical downlink shared channel (PDSCH), a medium access control-control element (MAC-CE) that activates a subset of transmission configuration indicator (TCI) states from a list of TCI states;
transmit, to the network entity, an acknowledgement (ACK) for the PDSCH on a physical uplink shared channel (PUSCH); and
communicate with the network entity based on an action time associated with the activated subset of TCI states, wherein the action time is based on a TCI activation delay from a last symbol of the PUSCH that includes the ACK for the PDSCH.

16. The apparatus of claim 15, wherein the PUSCH comprises one or more PUSCH transmission occasions in one or more slots, and wherein the receiving comprises receiving on at least one of the one or more PUSCH transmission occasions in each slot of the one or more slots.

17. The apparatus of claim 15, wherein the processor is further caused to:
receive, from the network entity, a radio resource control (RRC) signaling configuring the list of TCI states and the action time associated with the activated subset of TCI states.

18. The apparatus of claim 15, wherein the processor is further caused to: transmitting, to the network entity, a UE capability report indicating a UE capability of the UE for PUSCH-based acknowledgment/negative-acknowledgment, ACK/NACK, feedback for TCI activation.

19. The apparatus of claim 15, wherein the activated subset of TCI states is applied from a first slot that is a time duration of the TCI activation delay after the last symbol of the PUSCH with the ACK.

20. The apparatus of claim 15, wherein the MAC-CE indicates the action time is based on a TCI activation delay from a last symbol of the PUSCH or a last symbol of a PUSCH transmission occasion that includes the ACK for the PDSCH.
